(19) United States
(12) Patent Application Publication
(10) Pub. No.: US 2015/0016381 A1
(43) Pub. Date: Jan. 15, 2015

(54) RE-SELECTION OPTIMIZATION FOR PACKET AND CIRCUIT SWITCHED CONNECTIONS

(71) Applicants: Jorma Kaikkonen, Oulu (FI); Jussi-Pekka Koskinen, Oulu (FI); Jarkko Koskela, Oulu (FI)

(72) Inventors: Jorma Kaikkonen, Oulu (FI); Jussi-Pekka Koskinen, Oulu (FI); Jarkko Koskela, Oulu (FI)

(73) Assignee: Nokia Corporation, Espoo (FI)

(21) Appl. No.: 14/380,179

(22) PCT Filed: Mar. 6, 2012
(86) PCT No.: PCT/IB2012/051050

§ 371 Date: Aug. 21, 2014

(51) Int. Cl. H04W 48/18

(52) U.S. Cl. CPC H04W 48/18
USPC 370/329

(57) ABSTRACT

A user equipment UE determines from downlink signaling at least two different types of priority information for at least a first and a second cell. These cells operate simultaneously in a same area with different radio access technologies RATs (inter-RAT neighbors) and/or with different carrier frequencies (inter-frequency neighbors). The UE checks a characteristic of data that is to be wirelessly exchanged, and selects between those cells for establishing a wireless connection, based on which of those types of priority information correspond to that characteristic of the data. In the examples the different types of priority information are circuit switched CS and packet switched PS. The characteristic the UE checks for the data may be: CS voice call or PS data; volume; latency tolerance; active or background mode; and minimum QoS; to name a few. The downlink signaling may be broadcast or a page.

### TECHNICAL FIELD

This invention relates generally to wireless communications, and more specifically is directed toward simultaneous operation of circuit switched and packet switched networks in the same vicinity. This subject matter is related to what in the prior art is known as circuit switched fallback.

### BACKGROUND

This section is intended to provide a background or context to the invention that is recited in the claims. The description herein may include concepts that could be pursued, but are not necessarily ones that have been previously conceived, implemented or described. Therefore, unless otherwise indicated herein, what is described in this section is not prior art to the description and claims in this application and is not admitted to be prior art by inclusion in this section.

The following abbreviations that may be found in the specification and/or the drawing figures are defined as follows:
3GPP third generation partnership project
CS circuit switched
CS-FB circuit switched fallback
DL downlink
eNB E-UTRAN Node B (access node in the LTE system)
EPC evolved packet core
E-UTRAN evolved UTRAN (LTE)
LTE long term evolution
MO mobile originated
MT mobile terminated
NodeB access node in the UTRAN system
PS packet switched
RAT radio access technology
RF radio frequency
UE user equipment
UL uplink (UE towards network)
UTRAN universal terrestrial radio access network

Circuit switched fallback (CS-FB) was introduced in E-UTRAN (LTE) as an interim solution for voice calls in which the infrastructure of legacy radio access technologies (RATs) such as 3G is used for the voice call. FIG. 1A illustrates an example of the CS-FB concept; a mobile terminal/user equipment (UE) camping on an LTE system receives a mobile terminating (MT) voice call from the existing circuit switched (CS) domain via the LTE network (evolved packet core or EPC). The UE recognizes from the paging message it receives to setup that voice call that the network is calling the UE for CS-based voice, and therefore the UE switches to 3G. The two illustrated UEs in FIG. 1A represent the same UE at different points in time, UE in LTE is when the UE receives the page and UE in 3G is when the UE switches to the 3G system. The UE then responds in the 3G CS system to confirm acceptance of the call request/page. All of these messages are in what is termed the control plane, or c-plane. From this point onward all call control for the voice service is performed on the 3G side. The voice call is setup and as shown in FIG. 1A the call itself occurs in what is termed the user plane, or u-plane.

FIG. 1B illustrates the core network architecture for the CS-FB example of FIG. 1A. In the LTE core network/EPC there is a serving gateway (S-GW) and a packet data network gateway (P-GW) through which user data may pass. User control is handled by a mobility management entity (MME) which accesses the home subscriber server (HSS) to learn what services are allowed or restricted for a given UF, among other information. In the 3G core network, circuit switched user data passes over a lu-cs interface for routing through a mobile switching center/visited location register (MSC/VLR), and packet switched user data passes over a Iu-ps interface for routing through a serving GPRS support node (SSGN). Control interfaces within and between these core networks are shown at FIG. 1B via dashed lines.

Note at FIG. 1B that the EPC supporting CS-FB connects its own MME, which is packet switched and which provides EPC mobility management functionality, with the MSC/VLR which is circuit switched and which lies in the 3G CS domain. This interface is termed a SGs interface and is similar in function to the Gs interface that connects the circuit switched MSC/VLR with the packet switched SGSN within the confines of the 3G network. The CS-FB function uses this SGs interface to transfer the mobile terminating call requests from the CS domain to LTE, as well as to provide combined mobility management between the 30 CS domain and the EPC (which is all PS domain) to enable this transfer to take place.

One issue with CS-FB is that there may be an excessive delay in setting up the voice call, and this delay is particularly acute when an E-UTRAN to E-UTRAN voice call is set-up. This delay occurs regardless of whether the voice call is mobile-terminating (MT) or mobile-originating (MO). Excessive delay of course degrades the user experience, but additionally changing the service domain from PS to CS may also result in a reduction in the success rate of paging responses from the UE.

One cause of excessive delay is that the UE may be camped on a non-optimal RAT when CS or PS connection establishment is needed. For example when a CS connection is needed the UE may be camped on an E-UTRAN cell, or when a PS connection is needed the UE may be camped on a UTRAN cell, and so forth. After the connection is established the network would then perform a handover or CS fallback to the desired RAT. Handover and CS-FB procedures result in an additional signaling load to the network, and also additional delays and an increased possibility of interrupting the voice connection.

The current solution in LTE for addressing the above CS-FB issue is to set a high priority (or dedicated priority) for UTRAN, so that when a PS connection request is initiated a handover procedure is performed to E-UTRAN. This of course increases the total number of hand-overs, and additionally imposes an added delay for the data transmission. Further, for background type of traffic which is increasingly common with the proliferation of smart-phones and their related applications, it would be beneficial to transmit this background data in the UTRAN system without handover to E-UTRAN.

Further solutions for CS-FB may be seen at document C1-114523 by KT entitled CS/PS MODE 1 ENHANCEMENT TO IMPROVE CSFB VOICE SERVICES [3GPP TSG WG1 Meeting #75; San Francisco, USA; 14-18 November 2011]. Document C1-114522 from that same meeting is similar and has additional background.

Below is detailed a different approach which the inventors consider more effective in minimizing the delays that are inherent in the above solutions when a UE needs to re-select to a most appropriate cell/RAT to establish a new circuit switched or packet switched connection.

### BRIEF DESCRIPTION OF THE DRAWINGS:

FIG. 1A is a schematic overview illustrating one example of how circuit switched fallback operates.

FIG. 1B is a schematic diagram illustrating network architecture and interfaces for the circuit switched fallback example of FIG. 1A.

FIG. 2 is a logic flow diagram that illustrates from the perspective of a user equipment/device the operation of a method, and a result of execution by an apparatus of a set of computer program instructions embodied on a computer readable memory, in accordance with the exemplary embodiments of this invention.

FIG. 3 is a simplified block diagram of a user equipment and an E-UTRAN eNB access node which are exemplary devices suitable for use in practicing the exemplary embodiments of the invention.

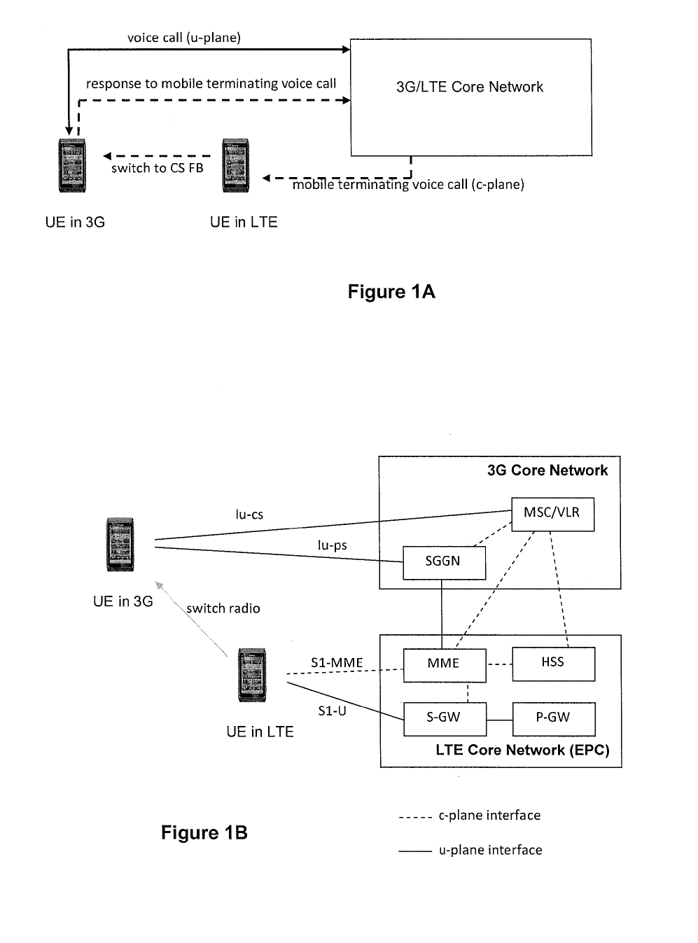

### SUMMARY

In a first exemplary aspect of the invention there is an apparatus which includes at least one processor and at least one memory including computer program code. The at least one memory and the computer program code are configured, with the at least one processor and in response to execution of the computer program code, to cause the apparatus to perform at least the following: determine from downlink signaling circuit at least two different types of priority information for at least a first cell and a second cell, in which the first and the second cells operate simultaneously in a same geographic area with different radio access technologies and/or with different carrier frequencies; and select between the first cell and the second cell for establishing a wireless connection based on a respective one of the different types of priority information corresponding to a different characteristic of data to be wirelessly exchanged.

In a second exemplary aspect of the invention there is a method which includes the following: determining from downlink signaling at least two different types of priority information for at least a first cell and a second cell, in which the first cell and the second cell operate simultaneously in a same geographic area with different radio access technologies and/or with different carrier frequencies; and selecting between the first cell and the second cell for establishing a wireless connection based on a respective one of the different types of priority information corresponding to a characteristic of data to be wirelessly exchanged.

In a third exemplary aspect of the invention there is a computer readable memory tangibly storing a program of computer readable instructions which when executed cause an apparatus at least to: determine from downlink signaling at least two different types of priority information for at least a first cell and a second cell, in which the first cell and the second cell operate simultaneously in a same geographic area with different radio access technologies and/or with different carrier frequencies; and select between the first cell and the second cell for establishing a wireless connection based on a respective one of the different types of priority information corresponding to a different characteristic of data to be wirelessly exchanged.

In a fourth exemplary aspect of the invention there is an apparatus which includes determining means and selecting means. The determining means is for determining from downlink signaling at least two different types of priority information for at least a first cell and a second cell, in which the first cell and the second cell operate simultaneously in a same geographic area with different radio access technologies and/or with different carrier frequencies. The selecting means is for selecting between the first cell and the second cell for establishing a wireless connection based on a respective one of the different types of priority information corresponding to a different characteristic of data to be wirelessly exchanged. In one non-limiting example the determining means and the selecting means is at least one processor running a computer program tangibly stored on a computer readable memory.

### DETAILED DESCRIPTION

The above latency and delay issues are resolved by certain example embodiments of these teachings, by which the network sends downlink signaling to the UE indicating separate packet switched and circuit switched priority information for the different types of radio access technologies (RATS) that are in use in the area. Each cell in the area has separate priorities for PS connections and for CS connections, and the UE is informed via downlink signaling of these priorities so the UE itself may choose which is the more appropriate cell for the data the UE has to send, since in many cases the type of data will determine which RAT is most appropriate. The UE can check certain characteristics of the data it has to send and then select the RAT (inter-RAT) or cell (intra-RAT) which has the PS or CS priority corresponding to that data characteristic(s). This PS and CS specific priority information may be signaled in addition to conventional priority information, which is not specific for CS or PS types of connections or data.

In one embodiment the network signals this information in dedicated signaling, such as for example when the network sends to the UE a page indicating an incoming voice call. In another embodiment the network signals this to all UEs in the cell via broadcast system information. In that latter embodiment the network may use a page to instruct an individual UE to apply the signaled CS and/or PS priority information for establishing a connection in response to receiving the page. For either embodiment, the UE is able to use a PS or a CS connection for any cell (re-)selections it may need to make, prior to establishing that connection, so as to establish its connection on the desired RAT. The advantages of this are particularly pronounced in the case the UE initiates the connection by sending a mobile originated PS or CS connection request.

In general the fact that the separate CS and PS priority information is available to the UE does not mean the UE must use it in all instances. For example, usage of the selected/additional priority information could be limited to the nature of the data that is to be exchanged, expressed above as one or more characteristics of the data. For example, in general the UE would not use a PS connection priority for background type of data such as smartphone applications that run in the background (email, social networking, etc.), and it may be the UE chooses to use the PS priority information only for high latency required data.

Consider a few other non-limiting examples.
If the type/characteristic of the data is whether it is CS or PS, then in one example data characterized as circuit switched voice calls corresponds to a circuit switched type of priority information, and data characterized as packet switched corresponds to a packet switched type of priority information.
If the type/characteristic of the data concerns its minimum latency requirements, data characterized as low latency tolerant corresponds to a circuit switched type of priority information, and data characterized as high latency tolerant corresponds to a packet switched type of priority information.
If the type/characteristic of the data concerns volume, data characterized as low volume corresponds to a circuit switched type of priority information, and data characterized as high volume corresponds to a packet switched type of priority information.
If the type/characteristic of the data concerns whether or not it is background data, data characterized as active mode data corresponds to a circuit switched type of priority information, and data characterized as background mode corresponds to a packet switched type of priority information.
If the type/characteristic of the data concerns QoS, data characterized as having a high minimum QoS corresponds to a circuit switched type of priority information, and data characterized as having a low minimum QoS corresponds to a packet switched type of priority information.

Using this CS or PS specific priority information, then the UE can change its own operational mode (see for example section 4.3 of 3GPP 24.301 v11.1.0, 2011-12) to select one of the RATs or restrict itself from selecting one of the RATS, based on whether the UE needs PS service (such as for interne browsing) or CS service (such as for a mobile originated voice call).

And further, for the case in which the network also has some knowledge of this type or characteristic of the relevant traffic (for example, latency requirements, background data, volume of traffic, etc.), the network may also adjust the priorities and/or the UE's cell re-selection process.

To better describe these teachings, following are some example embodiments in which the UE uses these CS and/or PS specific priorities to determine whether it should initiate a PS connection (such as for example when the UE prioritizes a PS connection for this data) or a CS connection in other cases (such as when latencies for CS connection set-up are to be minimized).

For example, where the UE currently has no packet data activity, or when PS connection establishment is not otherwise needed for the UE, the UE would perform its re-selection evaluation process as is conventional. But when the UE is to initiate a mobile originated PS connection the UE may do its cell re-selection evaluation using the PS connection priorities it received in the downlink signaling (system information of dedicated signaling as in the embodiments above). In one aspect the UE can simply use its most recent measurements of neighbor cells to do this re-evaluation, and in another aspect the UE may instead conduct a new search for the neighbor RAT cell or neighbor carrier frequencies of the same RAT and take a new measurement to use in its re-selection evaluation.

If the UE finds that the frequency/RAT of the neighbor cell has a higher priority than the frequency/RAT of the current/serving cell, and that this neighbor cell also meets the thresholds for re-selection (such as signal strength/quality as is conventional), the UE would then initiate a re-selection to that neighbor cell prior to its request procedure which initiates a mobile originated PS connection. In one particular embodiment the UE could use the PS connection priorities it received in downlink signaling only for those instances where the quality of service (QoS) requirements or the needed data amount/volume exceed some preset limits, if QoS and/or data volume are the characteristics the UE checks. Such preset limits may in some examples be set by the UE internally, and in other examples these limits are preset by the network and signaled to the UE.

As another example, assume the UE currently has no packet data activity or that CS connection establishment is not needed. In this case the UE would perform the re-selection evaluation process as is conventional. But where the UE is to initiate a mobile originated PS or CS connection the UE will also perform its re-selection evaluation using the PS or CS priority information it learned via downlink signaling. And in this example also the UE may use its most recent measurement information for this re-selection evaluation, or it may conduct a new search and take new measurements on which its re-selection evaluation will be based.

The above examples for how these teachings may be implemented can also minimize the UE's need for traffic area updates and the like. Additionally, they illustrate how these teachings may help minimize the UE's power consumption in the IDLE state by allowing the UE to camp in IDLE for longer than might be optimal for most services, except for the shorter latency time in setting up the proper connection which these teachings enable.

In both the network and in the UE the network access stratum (NAS) layer may be employed for changing information between the access stratum (AS) layer and the application layer. Typically the NAS layer has latency and throughput (and other) requirements about the ongoing traffic that are available for use by other layers. The AS layer of the network may then use this NAS layer information in order to determine the suitable priority settings and/or the used re-selection evaluation process (through dedicated signaling to the UE) in the case that there are multiple alternative re-selection procedures.

Some of the example embodiments above provide the following technical effects. For the case the UE uses the priority information to establish a PS connection, such a PS connection is established without delay in the most suitable RAT. For the case the priority information is used to establish a CS connection, that CS connection is established without delay in the most suitable RAT. Another technical effect is that the network signaling load is optimized. Additionally, interrupts to data transfer or voice calls due to frequent handovers is no longer an issue since the UE will be established on the most suitable RAT for them from the start.

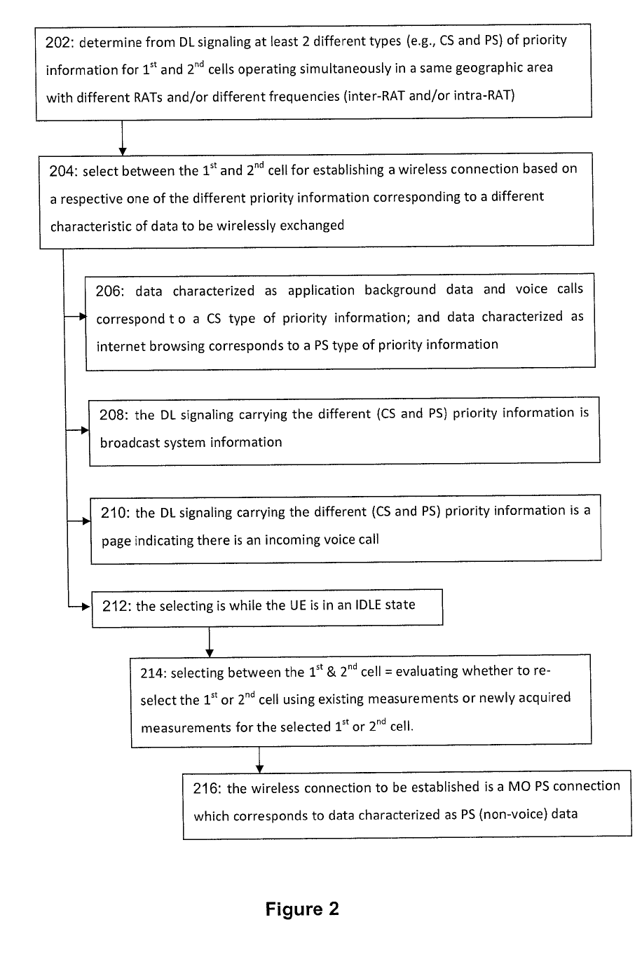

The logic flow diagram of FIG. 2 summarizes the various exemplary embodiments of the invention from the perspective of the UE (or certain components thereof if not performed by the entire UE), and may be considered to illustrate the operation of a method, and a result of execution of a computer program stored in a computer readable memory, and a specific manner in which components of an electronic device are configured to cause that electronic device to operate, whether such an electronic device is the access node in full or one or more components thereof such as a modem, chipset, or the like. FIG. 2 assumes the minimum of two cells operating on two different RATs, but these same principles are readily extended to more neighbor cells and operating on a total of more than only two RATs.

The various blocks shown at FIG. 2 may also be considered as a plurality of coupled logic circuit elements constructed to carry out the associated function(s), or specific result of strings of computer program code or instructions stored in a memory. Such blocks and the functions they represent are non-limiting examples, and may be practiced in various components such as integrated circuit chips and modules, and that the exemplary embodiments of this invention may be realized in an apparatus that is embodied as an integrated circuit. The integrated circuit, or circuits, may comprise circuitry (as well as possibly firmware) for embodying at least one or more of a data processor or data processors, a digital signal processor or processors, baseband circuitry and radio frequency circuitry that are configurable so as to operate in accordance with the exemplary embodiments of this invention.

At block 202 of FIG. 2 the UE determines from downlink signaling at least two different types of priority information (CS and PS priority information in the above non-limiting examples, but there may even be more than two) for at least a first cell and a second cell. These first and second cells operate simultaneously in a same geographic area with different RATs (known in the wireless arts as inter-RAT) and/or with different frequencies (known in the wireless arts as intra-RAT). For example, one is the serving cell operating with the E-UTRAN system and the other is a neighbor cell operating with the UTRAN or GERAN system or operating on a different carrier frequency of the E-UTRAN system. Note that these are non-limiting examples and these teachings may even be applied for RATs yet to be developed. Then at block 204 the UE selects between the first cell and the second cell for establishing a wireless connection, and that selection is based on a respective one of the different types of priority information (the CS or the PS priority information in the examples above) corresponding to a different (CS or a PS in the examples) characteristic of data that is to be wirelessly exchanged. In the above examples, when the UE characterizes its data as a circuit switched voice call, that characteristic corresponds to a circuit switched type of priority information; and when the UE characterizes its data as packet switched that characteristic corresponds to a packet switched type of priority information.

Further portions of FIG. 2 reflect some of the example embodiments above. Block 206 gives examples of the different characteristics of the data: data characterized as application background data and/or voice calls correspond to a CS type of priority information; and data characterized as internet browsing corresponds to a PS type of priority information. Above are detailed other characteristics the UE can use, relating to latency requirements/tolerances, data volume, active versus background, and QoS minimums.

Block 208 summarizes one of the above embodiments in which the downlink signaling in which the CS and the PS priority information is received comprises broadcast system information. Block 210 summarizes the other embodiment in which the downlink signaling in which the CS and the PS priority information is received comprises a page indicating there is an incoming voice call.

Block 212 provides that for any of the embodiments in previous blocks of FIG. 2, the UE does the selecting between the 1^{st} and 2^{nd} cells that was first stated at block 204 while that UE is in an IDLE state. Block 214 follows block 214 and provides that the selecting of block 204 comprises the UE evaluating whether to re-select the 1^{st} or 2^{nd} cell using existing measurements, or using newly acquired measurements, for the selected 1^{st} or 2^{nd} cell. And finally block 216 gives the example that the wireless connection to be established is a mobile-originated PS connection which corresponds to data characterized as PS (non-voice) data.

Not shown at FIG. 2 but detailed above is that the UE can use the PS priority information for data characterized as having a minimum required QoS (and/or data volume) that exceeds a preset limit. And in another embodiment noted above the selection between the first cell and the second cell radio is based (at least in part) on the needed RAT and/or carrier frequency for the case in which the data to be sent from the UE is characterized as having a volume that exceeds a preset limit.

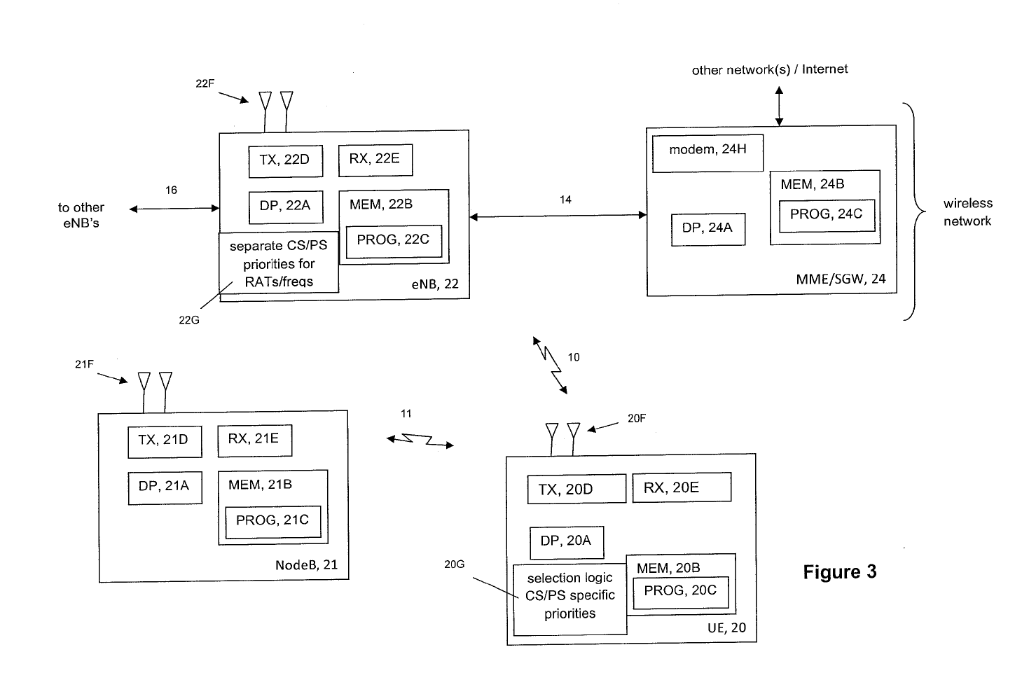

Reference is now made to FIG. 3 for illustrating a simplified block diagram of various electronic devices and apparatus that are suitable for use in practicing the exemplary embodiments of this invention. In FIG. 3 an eNB 22 is adapted for communication over a wireless link 10 with an apparatus, such as a mobile device/terminal such as a UE 20. FIG. 3 assumes the eNB 22 is the UE's serving cell, and while there are typically several UEs under control of the eNB 22, for simplicity only one UE 20 is shown at FIG. 3. The eNB 22 may be any access node (including frequency selective repeaters) of any wireless network such as LTE, LTE-A, GSM, GERAN, WCDMA, and the like. The operator network of which the eNB 22 is a part may also include a network control element such as a mobility management entity MME and/or serving gateway SGW 24 or radio network controller RNC which provides connectivity with further networks (e.g., a publicly switched telephone network and/or a data communications network/Internet).

There is also a neighbor cell NodeB 21 in FIG. 3, such that the eNB 22 and the NodeB 21 of FIG. 3 are in the position of the first and second cells which were detailed at FIG. 2. The NodeB 21 may have a wireless link 11 with the UE 20 by which the UE 20 under control of the eNB 22 measures signal strength/quality form the NodeB 21 for use in re-evaluating it for a new CS connection as in the above examples. While these access nodes 22/21 are shown as physically separate in some deployments they may be co-located; that is a single base station may operate with both E-UTRAN and UTRAN RATs.

The UE 20 includes processing means such as at least one data processor (DP) 20A, storing means such as at least one computer-readable memory (MEM) 20B storing at least one computer program (PROG) 20C or other set of executable instructions, communicating means such as a transmitter TX 20D and a receiver RX 20E for bidirectional wireless communications with the eNB 22 via one or more antennas 20F. Also stored in the MEM 20B at reference number 20G is the UE's algorithm or function or selection logic for selecting a cell 22/21 for establishing a new connection, and that selection logic uses the PS and/or CS specific priority information which the UE 20 receives downlink from one or the other of those cells 22/21 as detailed above.

The eNB 22 and the NodeB 21 also respectively includes processing means such as at least one data processor (DP) 22A/21A, storing means such as at least one computer-readable memory (MEM) 22B/21B storing at least one computer program (PROG) 22C/22C or other set of executable instructions, and communicating means such as a transmitter TX 22D/21D and a receiver RX 22E/21E for bidirectional wireless communications with the UE 20 (or UEs) via one or more antennas 22F/21F. The eNB 22 stores at block 22G the separate CS and PS priorities for itself and for its neighbor cell the NodeB 21, and it is these priorities that the eNB 22 signals DL to the UE 20 in system information or in dedicated signaling as noted above by example. The NodeB 21 may also have a similar set of separate CS and PS priorities for itself and for its neighbor cell(s) but is not specifically shown since in this example the eNB 22 is the UE's serving cell.

At least one of the PROGs 22C/22G and 21C in the eNB 22 and the NodeB 21 is assumed to include a set of program instructions that, when executed by the associated DP 22A/21A, enable the device to operate in accordance with the exemplary embodiments of this invention, as detailed above. The UE 20 also stores software 20C/20G in its MEM 20B to implement certain aspects of these teachings. In these regards the exemplary embodiments of this invention may be implemented at least in part by computer software stored on the MEM 20B, 22B, 21B which is executable by the DP 20A of the UE 20 and/or by the DP 22Al21A of the eNB 22/NodeB 21, or by hardware, or by a combination of tangibly stored software and hardware (and tangibly stored firmware). Electronic devices implementing these aspects of the invention need not be the entire devices as depicted at FIG. 3 or may be one or more components of same such as the above described tangibly stored software, hardware, firmware and DP, or a system on a chip SOC or an application specific integrated circuit ASIC.

In general, the various embodiments of the UE 20 can include, but are not limited to personal portable digital devices having wireless communication capabilities, including but not limited to cellular telephones, navigation devices, laptop/palmtop/tablet computers, digital cameras and music devices, and Internet appliances.

Various embodiments of the computer readable MEMs 20B, 21B, 22B include any data storage technology type which is suitable to the local technical environment, including but not limited to semiconductor based memory devices, magnetic memory devices and systems, optical memory devices and systems, fixed memory, removable memory, disc memory, flash memory, DRAM, SRAM, EEPROM and the like. Various embodiments of the DPs 20A, 21A, 22A include but are not limited to general purpose computers, special purpose computers, microprocessors, digital signal processors (DSPs) and multi-core processors.

Various modifications and adaptations to the foregoing exemplary embodiments of this invention may become apparent to those skilled in the relevant arts in view of the foregoing description. While the exemplary embodiments have been described above in the context of the E-UTRAN and UTRAN system, as noted above the exemplary embodiments of this invention may be used with various other types of wireless communication systems such as GERAN for example.

Further, some of the various features of the above non-limiting embodiments may be used to advantage without the corresponding use of other described features. The foregoing description should therefore be considered as merely illustrative of the principles, teachings and exemplary embodiments of this invention, and not in limitation thereof.

1-34. (canceled)

35. An apparatus comprising
at least one processor; and
at least one memory including computer program code; in which the at least one memory and the computer program code is configured, with the at least one processor, to cause the apparatus at least to:
determine from downlink signaling at least two different types of priority information for at least a first cell and a second cell, in which the first cell and the second cell operate simultaneously in a same geographic area with at least one of different radio access technologies and different carrier frequencies; and
select between the first cell and the second cell for establishing a wireless connection based on a respective one of the different types of priority information corresponding to a different characterization of data to be wirelessly exchanged.

36. The apparatus according to claim 35, wherein data characterized as circuit switched voice calls corresponds to a circuit switched type of priority information, and data characterized as packet switched corresponds to a packet switched type of priority information.

37. The apparatus according to claim 35, wherein data characterized as low latency tolerant corresponds to a circuit switched type of priority information, and data characterized as high latency tolerant corresponds to a packet switched type of priority information.

38. The apparatus according to claim 35, wherein data characterized as low volume corresponds to a circuit switched type of priority information, and data characterized as high volume corresponds to a packet switched type of priority information.

39. The apparatus according to claim 35, wherein data characterized as active mode data corresponds to a circuit switched type of priority information, and data characterized as background mode corresponds to a packet switched type of priority information.

40. The apparatus according to claim 35, wherein data characterized as having a high minimum quality of service corresponds to a circuit switched type of priority information, and data characterized as having a low minimum quality of service corresponds to a packet switched type of priority information.

41. The apparatus according to claim 35, in which the two different types of priority information comprises packet switched and circuit switched priority information, and the downlink signaling in which the circuit switched and the packet switched priority information is received comprises broadcast system information.

42. The apparatus according to claim 35, in which the two different types of priority information comprises packet switched and circuit switched priority information, and the downlink signaling in which the circuit switched and the packet switched priority information is received comprises a page indicating there is an incoming voice call.

43. The apparatus according to claim 35, in which the apparatus comprises a user equipment and the selecting between the first cell and the second cell is while the user equipment is in an IDLE state.

44. The apparatus according to claim 43, wherein the selecting between the first cell and the second cell for establishing a wireless connection comprises the user equipment evaluating whether to re-select the first or the second cell using existing measurements or newly acquired measurements for the selected first or second cell.

45. The apparatus according to claim 35, in which the two different types of priority information comprises packet switched and circuit switched priority information and the apparatus is configured to use the packet switched priority information for data characterized as having a minimum required quality of service that exceeds a preset limit.

46. The apparatus according to claim 35, in which the apparatus is configured to select between the first cell and the second cell radio based on at least one of their respective radio access technologies and respective carrier frequencies for data characterized as having a volume that exceeds a preset limit.

47. A method comprising:
determining from downlink signaling at least two different types of priority information for at least a first cell and a second cell, in which the first cell and the second cell operate simultaneously in a same geographic area with different radio access technologies and/or with different carrier frequencies; and
selecting between the first cell and the second cell for establishing a wireless connection based on a respective one of the different types of priority information corresponding to a different characterization of data to be wirelessly exchanged.

48. The method according to claim 47, wherein data characterized as circuit switched voice calls corresponds to a circuit switched type of priority information, and data characterized as packet switched corresponds to a packet switched type of priority information.

49. The method according to claim 47, wherein data characterized as low latency tolerant corresponds to a circuit switched type of priority information, and data characterized as high latency tolerant corresponds to a packet switched type of priority information.

50. The method according to claim 47, wherein data characterized as low volume corresponds to a circuit switched type of priority information, and data characterized as high volume corresponds to a packet switched type of priority information.

51. The method according to claim 47, wherein data characterized as active mode data corresponds to a circuit switched type of priority information, and data characterized as background mode corresponds to a packet switched type of priority information.

52. The method according to claim 47, wherein data characterized as having a high minimum quality of service corresponds to a circuit switched type of priority information, and data characterized as having a low minimum quality of service corresponds to a packet switched type of priority information.

53. The method according to claim 47, in which the two different types of priority information comprises packet switched and circuit switched priority information, and the downlink signaling in which the circuit switched and the packet switched priority information is received comprises broadcast system information.

54. The method according to claim 47, in which the two different types of priority information comprises packet switched and circuit switched priority information, and the downlink signaling in which the circuit switched and the packet switched priority information is received comprises a page indicating there is an incoming voice call.
